(19) United States
(12) Patent Application Publication
(10) Pub. No.: US 2026/0333025 A1
(43) Pub. Date: Oct. 22, 2026

(54) DATA SENSING METHOD, AND CORE NETWORK SYSTEM, CORE NETWORK NETWORK ELEMENT AND CHIP

(71) Applicant: Beijing Xiaomi Mobile Software Co., Ltd., Beijing (CN)

(72) Inventor: Jinhua WU, Beijing (CN)

(73) Assignee: Beijing Xiaomi Mobile Software Co., Ltd., Beijing (CN)

(21) Appl. No.: 19/112,092

(22) PCT Filed: Sep. 20, 2022
(86) PCT No.: PCT/CN2022/120016

§ 371 Date: Mar. 14, 2025

(51) Int. Cl. H04W 12/02; H04W 4/38; H04W 12/08

(52) U.S. Cl. CPC H04W 12/02; H04W 4/38; H04W 12/08

(57) ABSTRACT

The present disclosure relates to a data sensing method, and a core network system, a core network element and a chip. The method comprises: sending first information to a terminal to be subjected to sensing, wherein the first information is used by said terminal to determine a result of sensing privacy verification; and receiving second information, which is sent by said terminal, wherein the second information comprises the result of sensing privacy verification, and the result of sensing privacy verification is used for indicating permission for a sensing requester to perform target-data sensing on said terminal. By means of the method, the security of a terminal to be subjected to sensing can be improved.

### TECHNICAL FIELD

The present disclosure relates to the field of communication technology, in particular, to a data sensing method, a core network system, a core network network element, and a chip.

### BACKGROUND

The wireless sensing technology aims at acquiring information about a remote object and characteristics of the object without physical contact. The sensed data from the object can be utilized for analysis, so that meaningful information about the object or the surroundings of the object can be obtained, which can be used to assist in radio resource management, interference mitigation, beam management, mobility, etc., so as to bring benefits in multiple segmented markets and vertical fields, such as intelligent transportation, aviation, enterprises, smart cities, smart homes, factories, consumer applications, public sectors, etc.

However, the object to be sensed in the data sensing method in the related art is of low security.

### SUMMARY

To overcome the above-mentioned problems in the related art, the present disclosure provides a data sensing method, a data sensing device, a core network system, a core network network element, a storage medium, and a chip.

According to a first aspect of embodiments of the present disclosure, a data sensing method is provided. The method is performed by a core network, and includes:

sending first information to a sensed-object terminal, wherein the first information is configured for the sensed-object terminal to determine a result of a sensing privacy verification; and receiving second information sent by the sensed-object terminal, wherein the second information includes the result of the sensing privacy verification, and the result of the sensing privacy verification is configured to indicate authority of a sensing requester to perform target data sensing on the sensed-object terminal.

According to a second aspect of embodiments of the present disclosure, a data sensing method is provided. The method is performed by a sensed-object terminal, and includes:
receiving first information sent by a core network;
determining a result of a sensing privacy verification in response to the first information; and
sending second information to the core network, wherein the second information includes the result of the sensing privacy verification, and the result of the sensing privacy verification is configured to indicate authority of a sensing requester to perform target data sensing on the sensed-object terminal.

According to a third aspect of embodiments of the present disclosure, a core network system is provided. The core network system includes a first network element, a Policy Control Function (PCF) network element, and an Access and Mobility Management Function (AMF) network element.

The first network element is configured to determine first information and a second identifier of a sensed-object terminal, and send the first information and the second identifier to the PCF network element.

The PCF network element is configured to send the first information and the second identifier to the AMF network element.

The AMF network element is configured to send the first information to a terminal corresponding to the second identifier, and receive second information sent by the sensed-object terminal, wherein the second information includes a result of a sensing privacy verification, and the result of the sensing privacy verification is configured to indicate authority of a sensing requester to perform target data sensing on the sensed-object terminal.

According to a fourth aspect of embodiments of the present disclosure, a core network network element is provided. The core network network element is connected to a Policy Control Function (PCF) network element in the core network. The core network network element is configured to determine first information and a second identifier, and send the first information to a sensed-object terminal corresponding to the second identifier through the PCF network element. The first information is configured for the sensed-object terminal to determine a result of a sensing privacy verification.

According to a fifth aspect of embodiments of the present disclosure, a data sensing apparatus is provided. The apparatus is applied to a core network, and includes:

a first sending module configured to send first information to a sensed-object terminal, wherein the first information is configured for the sensed-object terminal to determine a result of a sensing privacy verification; and a first receiving module configured to receive second information sent by the sensed-object terminal, wherein the second information includes the result of the sensing privacy verification, and the result of the sensing privacy verification is configured to indicate authority of a sensing requester to perform target data sensing on the sensed-object terminal.

According to a sixth aspect of embodiments of the present disclosure, a data sensing apparatus is provided. The apparatus is applied to a sensed-object terminal, and includes:

a third receiving module configured to receive first information sent by a core network;

a determination module configured to determine a result of a sensing privacy verification in response to the first information, and a third sending module configured to send second information to the core network, wherein the second information includes the result of the sensing privacy verification, and the result of the sensing privacy verification is configured to indicate authority of a sensing requester to perform target data sensing on the sensed-object terminal.

According to a seventh aspect of embodiments of the present disclosure, a data sensing device is provided. The device includes:
a processor; and
a memory for storing instructions executable by the processor;
wherein the processor is configured to execute steps of the data sensing method provided in the first aspect of the present disclosure.

According to an eighth aspect of embodiments of the present disclosure, a data sensing device is provided. The device includes:
a processor; and
a memory for storing instructions executable by the processor;
wherein the processor is configured to execute steps of the data sensing method provided in the second aspect of the present disclosure.

According to a ninth aspect of embodiments of the present disclosure, a computer-readable storage medium storing computer program instructions is provided. When the computer program instructions are executed by a processor, steps of the data sensing method provided in the first aspect of the present disclosure are executed.

According to a tenth aspect of embodiments of the present disclosure, a computer-readable storage medium storing computer program instructions is provided. When the computer program instructions are executed by a processor, steps of the data sensing method provided in the second aspect of the present disclosure are executed.

According to an eleventh aspect of embodiments of the present disclosure, a chip is provided. The chip includes a processor and an interface. The processor is configured to read instructions to execute steps of the data sensing method provided in the first aspect of the present disclosure.

According to a twelfth aspect of embodiments of the present disclosure, a chip is provided. The chip includes a processor and an interface. The processor is configured to read instructions to execute steps of the data sensing method provided in the second aspect of the present disclosure.

According to the above technical solutions, the first information for determining the result of the sensing privacy verification can be sent to the sensed-object terminal through the core network, and the second information including the result of the sensing privacy verification can be received through the core network. Due to the fact that the result of the sensing privacy verification is used to indicate the authority of the sensing requester to perform the target data sensing on the sensed-object terminal, the sensed-object terminal can verify the sensing authority of the sensing requester, and then decide whether to agree with the sensing requester to perform the target data sensing on it (the sensed-object terminal). By means of the authority verification process, the transmission process of the sensed data by the sensed-object terminal can be protected and the security of the sensed-object terminal can be improved.

It should be understood that the general description in the above and the detailed description in the following are only exemplary and explanatory, and cannot limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure.

FIG. 1 is a schematic diagram of a communication system according to one or more embodiments of the present disclosure.

FIG. 2 is a schematic diagram of another communication system according to one or more embodiments of the present disclosure.

FIG. 3 is a flowchart of a data sensing method according to one or more embodiments of the present disclosure.

FIG. 4 is a flowchart of a data sensing method according to one or more embodiments of the present disclosure.

FIG. 5 is a flowchart of a data sensing method according to one or more embodiments of the present disclosure.

FIG. 6 is a flowchart of a data sensing method according to one or more embodiments of the present disclosure.

FIG. 7 is a flowchart of a data sensing method according to one or more embodiments of the present disclosure.

FIG. 8 is a flowchart of a data sensing method according to one or more embodiments of the present disclosure.

FIG. 9 is a flowchart of a data sensing method according to one or more embodiments of the present disclosure.

FIG. 10 is a flowchart of a data sensing method according to one or more embodiments of the present disclosure.

FIG. 11 is a flowchart of a data sensing method according to one or more embodiments of the present disclosure.

FIG. 12 is a flowchart of a data sensing method according to one or more embodiments of the present disclosure.

FIG. 13 is a flowchart of a data sensing method according to one or more embodiments of the present disclosure.

FIG. 14 is a flowchart of a data sensing method according to one or more embodiments of the present disclosure.

FIG. 15 is a core network system according to one or more embodiments of the present disclosure.

FIG. 16 is a flowchart of a data sensing method according to one or more embodiments of the present disclosure.

FIG. 17 is a flowchart of a data sensing method according to one or more embodiments of the present disclosure.

FIG. 18 is a block diagram of a data sensing apparatus according to one or more embodiments of the present disclosure.

FIG. 19 is a block diagram of a data sensing apparatus according to one or more embodiments of the present disclosure.

FIG. 20 is a block diagram of a data sensing device according to one or more embodiments of the present disclosure.

FIG. 21 is a block diagram of a data sensing device according to one or more embodiments of the present disclosure.

### DETAILED DESCRIPTION

Exemplary embodiments will be described in detail here, with examples shown in the drawings. When referring to the drawings, unless otherwise indicated, the same numbers in different drawings represent the same or similar elements. The embodiments described in the following exemplary embodiments do not represent all embodiments consistent with the present disclosure. On the contrary, they are only examples of devices and methods consistent with some aspects of the present disclosure as described in the appended claims.

It should be noted that all actions to obtain signals, information, or data in the present disclosure are carried out in accordance with the corresponding data protection regulations and policies of the country where they are located, and with authorization granted by the corresponding device owner.

In the present disclosure, terms such as “first”, “second”, etc. are used to distinguish similar objects and do not necessarily need to be understood as a specific order or sequence. In addition, unless otherwise indicated, in the description of the drawings, the same reference numerals in different drawings represent the same elements.

In the present disclosure, unless otherwise indicated, “multiple” refers to two or more, and other quantifiers are similar to this. The expressions such as “at least one of”, “one or more”, or similar expressions refer to any combination of these items, including any combination of single or multiple items. For example, one or more of a, b, or c, which can represent: a, b, c, a-b, a-c, b-c, or a-b-c, where a, b, and c can be single or multiple. The expression “and/or” describes an association relationship between related objects, indicating that there can be three types of relationships. For example, A and/or B can represent the existence of A alone, the existence of A and B at the same time, and the existence of B alone, where A and B can be singular or plural.

Although operations are described in a specific order in the drawings in embodiments of the present disclosure, it should not be understood as requiring the execution of these operations in the specific order or serial order shown in the drawings, or requiring the execution of all shown operations to obtain the desired results. In specific environments, multitasking and parallel processing may be advantageous. In addition, sending multiple messages through the same message is also advantageous.

The implementation environment of embodiments of the present disclosure will be introduced in the following first.

The technical solutions of embodiments of the present disclosure can be applied to various communication systems. The communication systems can include one or more of 4G (the 4th Generation) communication system, 5G (the 5th Generation) communication system, and other future wireless communication systems (such as 6G). The communication systems can also include one or more of Public Land Mobile Network (PLMN) networks, Non Terrestrial Network (NTN) communication systems, Device to Device (D2D) communication systems, Machine to Machine (M2M) communication systems, Internet of Things (IOT) communication systems, Vehicle to Everything (V2X) communication systems, or other communication systems.

FIG. 1 is a schematic diagram of a communication system according to one or more embodiments of the present disclosure. As shown in FIG. 1, the communication system can include a sensed-object terminal 101, a core network 102, and a sense-requesting terminal 103. The communication system can be used to support 4G (the 4th Generation) network access technology, such as Long Term Evolution (LTE) access technology, or 5G (the 5th Generation) network access technology, such as New Radio Access Technology (New RAT), or other future wireless communication technologies. It should be noted that in this communication system, the number of sensed-object terminals 101 or sense-requesting terminals 103 mentioned above can be one or multiple. The number of sensed-object terminals 101 or sense-requesting terminals 103 in the communication system shown in FIG. 1 is only for an example adaptive to embodiments, and the present disclosure does not limit this.

The sensed-object terminal 101 or the sense-requesting terminal 103 in FIG. 1 can be an electronic device that provides voice or data connectivity, which, for example, can be referred to as user equipment (UE), subscriber unit, mobile station, station, terminal device, etc. For example, the terminal can include a smartphone, a smart wearable device, a smart speaker, a smart tablet, a wireless modem, a wireless local loop (WLL) station, a personal digital assistant (PDA), a customer premise equipment (CPE), etc. With the development of the wireless communication technology, all devices that can access the communication system, communicate with the base station of the communication system, or communicate with other objects through the communication system can be terminals in embodiments of the present disclosure, such as terminals and cars in the intelligent transportation, household devices in smart homes, power meter reading instruments, voltage monitoring instruments, and environmental monitoring instruments in smart grids, video monitoring instruments in smart security networks, cash registers, etc.

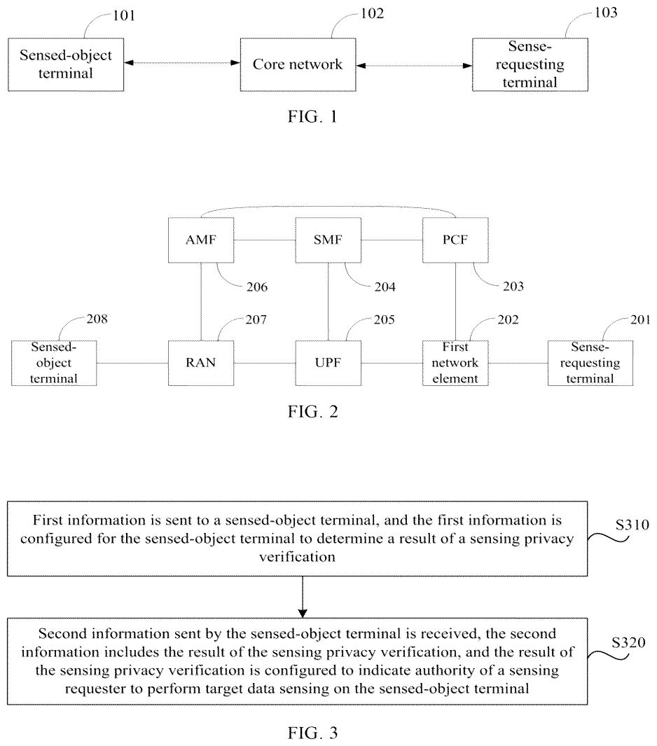

FIG. 2 is a schematic diagram of another communication system according to one or more embodiments of the present disclosure. As shown in FIG. 2, the communication system can include a sense-requesting terminal 201, a Sensing Application Function (SAF) network element (first network element) 202, a Policy Control Function (PCF) network element 203, a Session Management Function (SMF) network element 204, a User Plane Function (UPF) network element 205, an Access and Mobility Management Function (AMF) network element 206, a Radio Access Network (RAN) 207, and a sensed-object terminal 208.

It should be noted that in the communication system shown in FIG. 2, there can be only some of the devices participating in the data sensing method of embodiments of the present disclosure.

Some common scenarios to which the data sensing method provided in embodiments of the present disclosure is applied will be introduced in the following. The data sensing method provided in embodiments of the present disclosure can be applied to scenarios as follows.

Environmental real-time monitoring: wireless signals are used to reconstruct the environmental map, to further improve positioning accuracy, and enable environmental related applications, such as realizing an array of real-time monitoring related applications including dynamic 3D maps for driving assistance, pedestrian flow statistics, intrusion detection, traffic detection, etc.

Autonomous vehicle/UAV: autonomous vehicle/UAV applications have some common functional requirements. For example, autonomous vehicles/UAVs shall support Detection and Avoidance (DAA) to avoid obstacles. Meanwhile, autonomous vehicles/UAVs shall have the capability to monitor path information, like selecting routes, complying with traffic regulations. Therefore, the sensed data can be utilized to assist in obstacle avoidance and path information monitoring.

Air pollution monitoring: the quality of the received wireless signal exhibits different attenuation characteristics with changes in air humidity, air particulate matter (PM) concentration, carrier frequency, etc. Therefore, the sensed data can be utilized to help with weather or air quality detection.

Indoor healthcare and intrusion detection: the respiration rate estimation, breathing depth estimation, apnea detection, monitoring of vital signs in the elderly, and indoor intrusion detection can be realized.

It should be noted that the type of the sensed data from the sensed-object terminal can be different under different scenario requirements.

For example, the sensed data can be the location and channel environment of the sensed-object terminal, which can be used to help narrow the beam sweeping range and shorten the beam training time.

For example, the sensed data can be the position, velocity, motion trajectory, and channel environment of the sensed-object terminal for beam prediction, which can be used to reduce the overhead of beam measurement and the delay of beam tracking.

For example, the sensed data can be properties (such as direction, size, shape, etc.) of the sensed-object terminal and the channel environment of the sensed-object terminal, which can be used to improve the performance of channel estimation.

In addition to the above examples, the sensed data can also be data such as the trajectory of the sensed-object terminal.

It should be noted that the sensed data can be data sensed by the sensed-object terminal itself or data received by the sensed-object terminal from the external environment.

FIG. 3 shows a data sensing method according to one or more embodiments of the present disclosure, which can be applied to the core network in the above communication system. As shown in FIG. 3, the method can include following steps.

In step S310, first information is sent to a sensed-object terminal, and the first information is configured for the sensed-object terminal to determine a result of a sensing privacy verification.

In step S320, second information sent by the sensed-object terminal is received, the second information includes the result of the sensing privacy verification, and the result of the sensing privacy verification is configured to indicate authority of a sensing requester to perform target data sensing on the sensed-object terminal.

Based on the above content, in embodiments of the present disclosure, the sensed-object terminal can be understood as the terminal that sends the sensed data. In some embodiments, the sensed-object terminal can obtain the sensed data in various ways. For example, the sensed-object terminal can obtain the sensed data through the detection using its own sensors, or by processing the detected data together with a processor, or by receiving sensed data from other devices.

In addition, the sensing requester can be understood as the terminal that requests for the sensed data from the sensed-object terminal. In some embodiments, the sensing requester can be the core network itself or other terminals connected to the core network.

In some embodiments, the target data can be understood as a certain type of sensed data requested by the sensing requester from the sensed-object terminal according to the scenario requirements.

In some embodiments, the authority of the sensing requester to perform the target data sensing on the sensed-object terminal can include that the sensed-object terminal agrees with the sensing requester to perform the target data sensing, which means that the sensing requester can obtain the target data from the sensed-object terminal through the core network. The authority of the sensing requester to perform the target data sensing on the sensed-object terminal can also include that the sensed-object terminal refuses the target data sensing to be performed by the sensing requester, which means that the sensing requester cannot obtain the target data from the sensed-object terminal through the core network.

In some embodiments, the information configured to indicate the authority of the sensing requester to perform the target data sensing on the sensed-object terminal includes at least one of the following: information indicating that the sensing requester is allowed to perform the target data sensing on the sensed-object terminal, information indicating that the sensing requester is not allowed to perform the target data sensing on the sensed-object terminal, information indicating a reason for not allowance of the sensing requester to perform the target data sensing on the sensed-object terminal, an identifier of a device that is allowed to perform the target data sensing on the sensed-object terminal, or an identifier of a device that is not allowed to perform the target data sensing on the sensed-object terminal.

In some embodiments, the identifiers of devices that are allowed to perform the target data sensing on the sensed-object terminal can be multiple, and the identifiers of devices that not allowed to perform the target data sensing on the sensed-object terminal can also be multiple.

In embodiments of the present disclosure, the second information can include multiple fields, which can be used to be filled with the information indicating that the sensing requester is allowed to perform the target data sensing on the sensed-object terminal, the information indicating that the sensing requester is not allowed to perform the target data sensing on the sensed-object terminal, the information indicating the reason for not allowance of the sensing requester to perform the target data sensing on the sensed-object terminal, the identifier of the device that is allowed to perform the target data sensing on the sensed-object terminal, and the identifier of the device that is not allowed to perform the target data sensing on the sensed-object terminal, depending on the actual situations.

In some embodiments, under some cases, for example, the information indicating that the sensing requester is not allowed to perform the target data sensing on the sensed-object terminal, as well as the information indicating the reason for not allowance of the sensing requester to perform the target data sensing on the sensed-object terminal, can be simultaneously filled in different fields of the second information.

It should be noted that the result of the sensing privacy verification determined by the sensed-object terminal can be determined by the sensed-object terminal itself based on the first information, or can be generated by the sensed-object terminal by receiving a trigger operation from a user on an input operation control corresponding to the result of the sensing privacy verification.

In some embodiments, the first information can include a first identifier of the sensing requester (e.g., a core network or a sense-requesting terminal connected to the core network), information indicating a type of target data to be sensed, and sensing privacy verification indication information.

According to the above method provided by embodiments of the present disclosure, the first information for determining the result of the sensing privacy verification can be sent to the sensed-object terminal through the core network, and the second information including the result of the sensing privacy verification can be received through the core network. Due to the fact that the result of the sensing privacy verification is used to indicate the authority of the sensing requester to perform the target data sensing on the sensed-object terminal, the sensed-object terminal can verify the sensing authority of the sensing requester, and then decide whether to agree with the sensing requester to perform the target data sensing on it (the sensed-object terminal). By means of the authority verification process, the transmission process of the sensed data by the sensed-object terminal can be protected and the security of the sensed-object terminal can be improved.

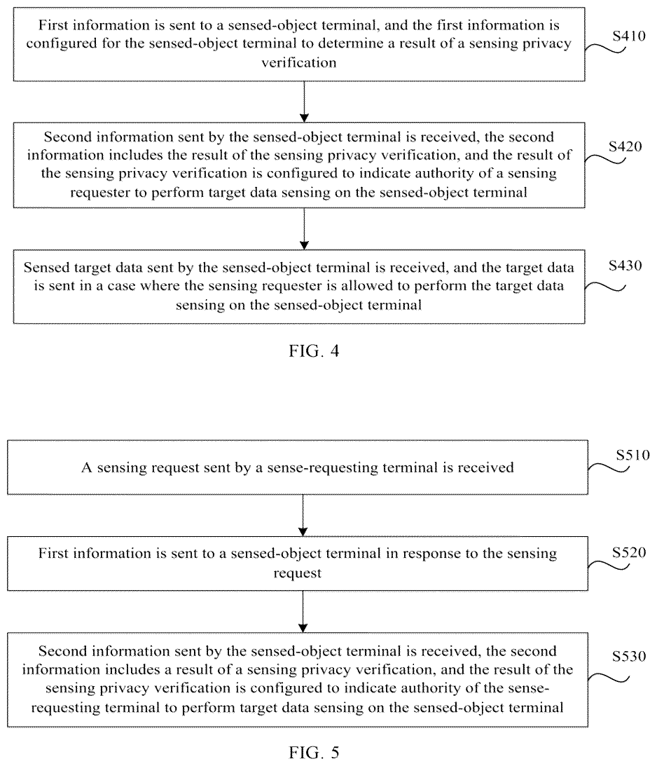

FIG. 4 shows a data sensing method according to one or more embodiments of the present disclosure, which can be applied to the core network. As shown in FIG. 4, the method can include following steps.

In step S410, first information is sent to a sensed-object terminal, and the first information is configured for the sensed-object terminal to determine a result of a sensing privacy verification.

The step S410 in some embodiments of the present disclosure is the same as step S310 described in the above, and can refer to step S310 described in the above, which will not be repeated here.

In step S420, second information sent by the sensed-object terminal is received, the second information includes the result of the sensing privacy verification, and the result of the sensing privacy verification is configured to indicate authority of a sensing requester to perform target data sensing on the sensed-object terminal.

In step S430, sensed target data sent by the sensed-object terminal is received, and the target data is sent in a case where the sensing requester is allowed to perform the target data sensing on the sensed-object terminal.

In embodiments of the present disclosure, if the result of the sensing privacy verification is that the sensing requester is allowed to perform the target data sensing on the sensed-object terminal, the sensed-object terminal can send the sensed target data to the core network, so that the core network can receive the sensed target data sent by the sensed-object terminal.

In some embodiments, the core network can send the sensed target data to the sensing requester after receiving the sensed target data from the sensed-object terminal.

In some embodiments, the process of receiving the sensed target data sent by the sensed-object terminal in step S430 can be performed simultaneously with the process of receiving the second information sent by the sensed-object terminal in step S420, that is, the target data can be carried in the second information. That is, after the core network sends the first information to the sensed-object terminal, if the sensed-object terminal determines to agree with the sensing requester to perform the target data sensing on the sensed-object terminal, the sensed-object terminal can carry both the result of the sensing privacy verification and the target data in the second information and send them together to the core network.

In some embodiments, the process of receiving the sensed target data sent by the sensed-object terminal in step S430 and the process of receiving the second information sent by the sensed-object terminal in step S420 can also be independently performed in sequence. In this case, in some embodiments, the sensed-object terminal can actively send the sensed target data to the core network. In some other embodiments, the core network can send the sensed-object terminal a message configured to request for the target data, so that the sensed-object terminal can send the sensed target data to the core network in response to the message configured to request for the target data after the message configured to request for the target data is received by the sensed-object terminal.

According to the above method provided by embodiments of the present disclosure, the target data can be sent from the sensed-object terminal to the core network after the sensed-object terminal agrees with the sensing requester to perform the target data sensing on it, which can protect the transmission process of the sensed data by the sensed-object terminal and improve the security of the sensed-object terminal.

FIG. 5 shows a data sensing method according to one or more embodiments of the present disclosure, which can be applied to the core network. The sensing requester is a sense-requesting terminal connected to the core network. As shown in FIG. 5, the method can include following steps.

In step S510, a sensing request sent by a sense-requesting terminal is received.

In step S520, first information is sent to a sensed-object terminal in response to the sensing request.

In step S530, second information sent by the sensed-object terminal is received, the second information includes a result of a sensing privacy verification, and the result of the sensing privacy verification is configured to indicate authority of the sense-requesting terminal to perform target data sensing on the sensed-object terminal.

In embodiments of the present disclosure, when the sense-requesting terminal needs to obtain sensed data, the sense-requesting terminal can send a sensing request to the core network. After receiving the sensing request sent by the sense-requesting terminal, the core network can send first information to the sensed-object terminal in response to the sensing request, and then receive the second information sent by the sensed-object terminal.

In some embodiments, the process of sending the first information to the sensed-object terminal in step S520, and the process of receiving the second information sent by the sensed-object terminal in step S530, can refer to the embodiments described in the above and will not be repeated here.

In addition, in some embodiments, the method can further include the step of receiving the sensed target data sent by the sensed-object terminal, and the detailed description of this step can refer to the embodiments described in the above, which will not be repeated here.

According to the above method provided by embodiments of the present disclosure, the core network can send the first information to the sensed-object terminal upon receiving the sensing request sent by the sense-requesting terminal.

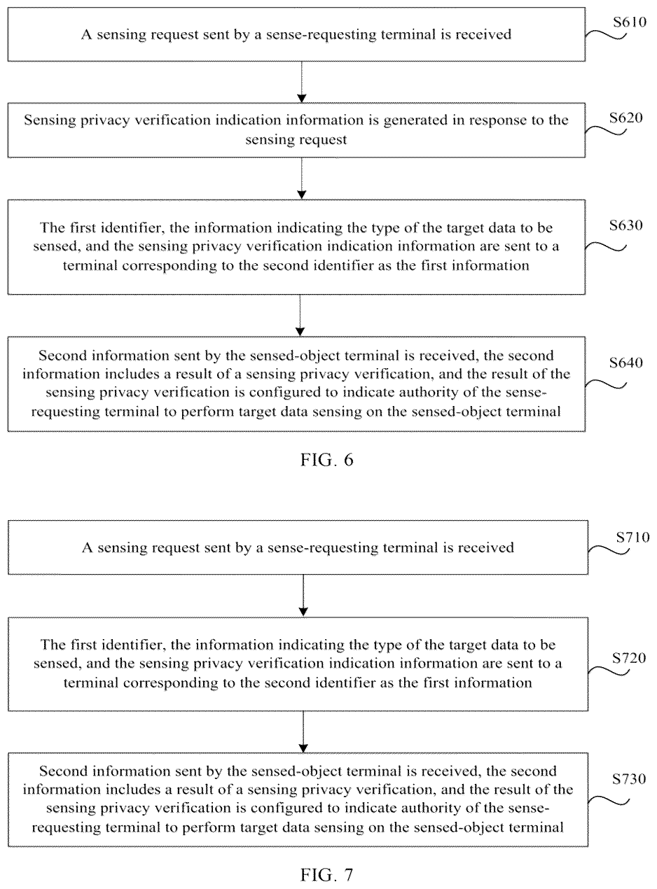

FIG. 6 shows a data sensing method according to one or more embodiments of the present disclosure, which can be applied to the core network. The sensing requester is the sense-requesting terminal connected to the core network. The sensing request includes a first identifier of the sense-requesting terminal, a second identifier of the sensed-object terminal, and information indicating a type of the target data to be sensed. As shown in FIG. 6, the method can include following steps.

In step S610, a sensing request sent by a sense-requesting terminal is received.

In step S620, sensing privacy verification indication information is generated in response to the sensing request.

In step S630, the first identifier, the information indicating the type of the target data to be sensed, and the sensing privacy verification indication information are sent as the first information to a terminal corresponding to the second identifier.

In step S640, second information sent by the sensed-object terminal is received, the second information includes a result of a sensing privacy verification, and the result of the sensing privacy verification is configured to indicate authority of the sense-requesting terminal to perform target data sensing on the sensed-object terminal.

The detailed descriptions of steps S610 and S640 can refer to the embodiments described in the above, and will not be repeated here.

According to the above method provided by embodiments of the present disclosure, the sensing request includes the first identifier of the sense-requesting terminal, the second identifier of the sensed-object terminal, and the information indicating the type of the target data to be sensed, but does not include the sensing privacy verification indication information. Therefore, when the core network receives the sensing request sent by the sense-requesting terminal and understands that the sense-requesting terminal wants to obtain sensed data from the sensed-object terminal, the core network can generate the sensing privacy verification indication information first. Then, the core network sends the first identifier, the information indicating the type of the target data to be sensed, and the sensing privacy verification indication information, as the first information, to the terminal corresponding to the second identifier, to instruct the sensed-object terminal to perform the sensing privacy verification and to return the second information.

In some embodiments, the first identifier can be a Generic Public Subscription Identifier (GPSI).

In some embodiments, the second identifier can be a Subscription Permanent Identifier (SUPI).

In addition, in some embodiments, the method can further include the step of receiving the sensed target data sent by the sensed-object terminal, and the detailed description of this step can refer to the embodiments described in the above, which will not be repeated here.

According to the above method provided by embodiments of the present disclosure, the sense-requesting terminal does not need to send the sensing request carrying sensing privacy verification indication information, that is, the sensing privacy verification indication information can be generated by the core network in response to the sensing request.

FIG. 7 shows a data sensing method according to one or more embodiments of the present disclosure, which can be applied to the core network. The sensing requester is the sense-requesting terminal connected to the core network. The sensing request includes a first identifier of the sense-requesting terminal, a second identifier of the sensed-object terminal, information indicating a type of the target data to be sensed, and sensing privacy verification indication information. As shown in FIG. 7, the method can include following steps.

In step S710, a sensing request sent by a sense-requesting terminal is received.

In step S720, the first identifier, the information indicating the type of the target data to be sensed, and the sensing privacy verification indication information are sent as the first information to a terminal corresponding to the second identifier.

In step S730, second information sent by the sensed-object terminal is received, the second information includes a result of a sensing privacy verification, and the result of the sensing privacy verification is configured to indicate authority of the sense-requesting terminal to perform target data sensing on the sensed-object terminal.

In some embodiments, the detailed descriptions of steps S710 and S730 can refer to the embodiments described in the above, and will not be repeated here.

In addition, in some embodiments, the method can further include the step of receiving the sensed target data sent by the sensed-object terminal, and the detailed description of this step can refer to the embodiments described in the above, which will not be repeated here.

According to the above method provided by embodiments of the present disclosure, the sense-requesting terminal can send the sensing request carrying the sensing privacy verification indication information, that is, the sensing privacy verification indication information can be sent by the sense-requesting terminal.

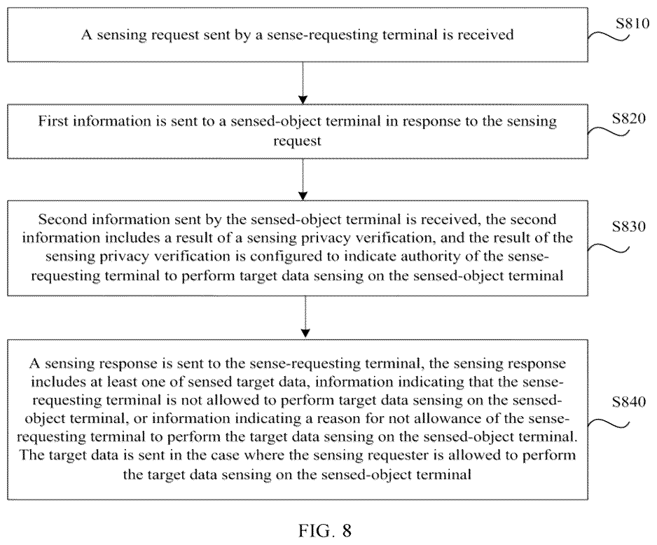

FIG. 8 shows a data sensing method according to one or more embodiments of the present disclosure, which can be applied to the core network. The sensing requester is the sense-requesting terminal connected to the core network. The sensing request includes a first identifier of the sense-requesting terminal, a second identifier of the sensed-object terminal, and information indicating a type of the target data to be sensed. As shown in FIG. 8, the method can include following steps.

In step S810, a sensing request sent by a sense-requesting terminal is received.

In step S820, first information is sent to a sensed-object terminal in response to the sensing request.

In step S830, second information sent by the sensed-object terminal is received, the second information includes a result of a sensing privacy verification, and the result of the sensing privacy verification is configured to indicate authority of the sense-requesting terminal to perform target data sensing on the sensed-object terminal.

In step S840, a sensing response is sent to the sense-requesting terminal, the sensing response includes at least one of sensed target data, information indicating that the sense-requesting terminal is not allowed to perform the target data sensing on the sensed-object terminal, or information indicating a reason for not allowance of the sense-requesting terminal to perform the target data sensing on the sensed-object terminal. The target data is sent in the case where the sensing requester is allowed to perform the target data sensing on the sensed-object terminal.

The detailed descriptions of steps S810 to S830 can refer to the embodiments described in the above, and will not be repeated here.

According to the above method provided by embodiments of the present disclosure, the core network can always send a sensing response to the sensing requester, regardless of whether the sensed-object terminal agrees with the sense-requesting terminal to perform the target data sensing. The sensing response can include at least one of the sensed target data, the information indicating that the sense-requesting terminal is not allowed to perform the target data sensing on the sensed-object terminal, or the information indicating the reason for not allowance of the sense-requesting terminal to perform the target data sensing on the sensed-object terminal. The target data is sent in the case where the sensing requester is allowed to perform the target data sensing on the sensed-object terminal.

In embodiments of the present disclosure, the sensing response can include multiple fields, which can be used to be filled with the sensed target data, the information indicating that the sense-requesting terminal is not allowed to perform the target data sensing on the sensed-object terminal, and the information indicating the reason for not allowance of the sense-requesting terminal to perform the target data sensing on the sensed-object terminal, depending on the actual situations.

That is, if the core network receives the target data sent by the sensed-object terminal, the core network can fill in the corresponding field of the sensing response with the target data, and send the target data to the sense-requesting terminal.

If the second information received by the core network is the information indicating that the sense-requesting terminal is not allowed to perform the target data sensing on the sensed-object terminal, the core network can fill in the corresponding field of the sensing response with the information indicating that the sense-requesting terminal is not allowed to perform the target data sensing on the sensed-object terminal, and send it to the sense-requesting terminal. If the second information further includes the information indicating the reason for not allowance of the sense-requesting terminal to perform the target data sensing on the sensed-object terminal, the core network can also fill in the corresponding field of the sensing response with the information indicating that the sense-requesting terminal is not allowed to perform the target data sensing on the sensed-object terminal and the information indicating the reason for not allowance of the sense-requesting terminal to perform the target data sensing on the sensed-object terminal, and send them to the sense-requesting terminal.

According to the above method provided by embodiments of the present disclosure, the core network can return the sensing response to the sense-requesting terminal to inform the sense-requesting terminal of the result of the sensing request.

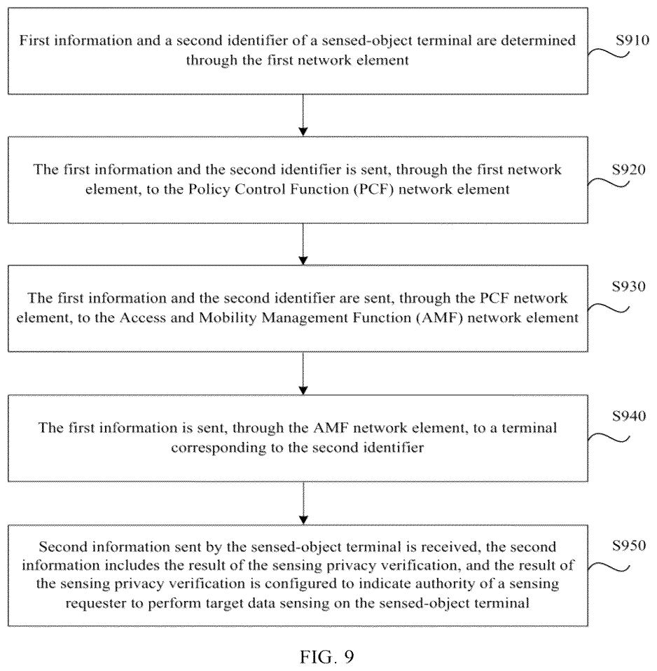

FIG. 9 shows a data sensing method according to one or more embodiments of the present disclosure, which can be applied to the core network. The core network includes a first network element, a Policy Control Function (PCF) network element, and an Access and Mobility Management Function (AMF) network element. As shown in FIG. 9, the method can include following steps.

In step S910, first information and a second identifier of a sensed-object terminal are determined through the first network element.

In some embodiments, the first information can include a first identifier of the sensing requester (e.g., a core network or a sense-requesting terminal connected to the core network), information indicating a type of target data to be sensed, and sensing privacy verification indication information.

In some embodiments, when the sensing requester is the core network, the first network element can obtain, from related devices in the core network, the first identifier corresponding to the core network, the information indicating the type of the target data to be sensed, and the sensing privacy verification indication information, thereby determining the obtained first identifier, information indicating the type of the target data to be sensed, and sensing privacy verification indication information as the first information. In addition, the first network element can directly obtain the second identifier from related functional devices in the core network.

In some embodiments, when the sensing requester is the sense-requesting terminal connected to the core network, the detailed descriptions about that the first network element determines the second identifier of the sensed-object terminal and the first information can refer to the embodiments described in the above, which will not be repeated here.

It should be noted that the first network element can be understood as a newly added network element in the core network. In some embodiments, the first network element can be referred to as a Sensing Application Function (SAF) network element.

In step S920, the first information and the second identifier is sent, through the first network element, to the Policy Control Function (PCF) network element.

In some embodiments, a first request can be sent to the PCF network element via the first network element. The first request includes the first information and the second identifier. It should be noted that the first request is a newly added request in embodiments of the present disclosure. For example, the first request can be a newly added Npcf_SensingPolicyControl Request. In some embodiments, the first information can include the first identifier of the sense-requesting terminal, the information indicating the type of the target data to be sensed, and the sensing privacy verification indication information. Therefore, the first request can include the first identifier, the information indicating the type of the target data to be sensed, and the sensing privacy verification indication information.

In step S930, the first information and the second identifier are sent, through the PCF network element, to the Access and Mobility Management Function (AMF) network element.

In some embodiments, a second request can be sent to the AMF network element via the PCF network element. The second request includes the second identifier and the first information. In some embodiments, the second request can be a Namf Communication_N1N2MessageTransfer request, which includes the second identifier and an N1 message, with the N1 message including the first information.

In step S940, the first information is sent, through the AMF network element, to a terminal corresponding to the second identifier.

In some embodiments, a notification message can be sent to the terminal corresponding to the second identifier via the AMF network element. The notification message includes the first information. In some embodiments, the notification message can be a Non Access Stratum (NAS) notification message, with the NAS notification message including the first information.

In step S950, second information sent by the sensed-object terminal is received, the second information includes the result of the sensing privacy verification, and the result of the sensing privacy verification is configured to indicate authority of a sensing requester to perform target data sensing on the sensed-object terminal.

According to the above method provided by embodiments of the present disclosure, the second identifier of the sensed-object terminal and the first information can be determined through the first network element first. After the first information and the second identifier of the sensed-object terminal are determined, the first information and the second identifier can be sent to the PCF network element through the first network element. Then, the first information and the second identifier can be sent to the AMF network element through the PCF network element. Next, the first information can be sent to the terminal corresponding to the second identifier through the AMF network element.

In some embodiments, the step S950, where the second information sent by the sensed-object terminal is received, can include following steps:

receiving the second information sent by the sensed-object terminal through the AMF network element, sending the second information to the PCF network element through the AMF network element, and sending the second information to the first network element through the PCF network element.

In some embodiments, a notification message response sent by the sensed-object terminal can be received through the AMF network element, the notification message response including the second information. In some embodiments, the notification message response can be a Non Access Stratum (NAS) notification response, with the NAS notification response including the second information.

In some embodiments, a second request response can be sent to the PCF network element through the AMF network element, with the second request response including the second information. In some embodiments, the second request response can be, for example, a Namf_Communication_N1N2MessageTransfer response, which includes the second information.

In some embodiments, a first request response can be sent to the first network element through the PCF network element, with the first request response including the second information. In some embodiments, the first request response can be, for example, a sensing policy control response (Npcf_SensingPolicyControl Response), which includes the second information. The sensing policy control response is a newly added response message.

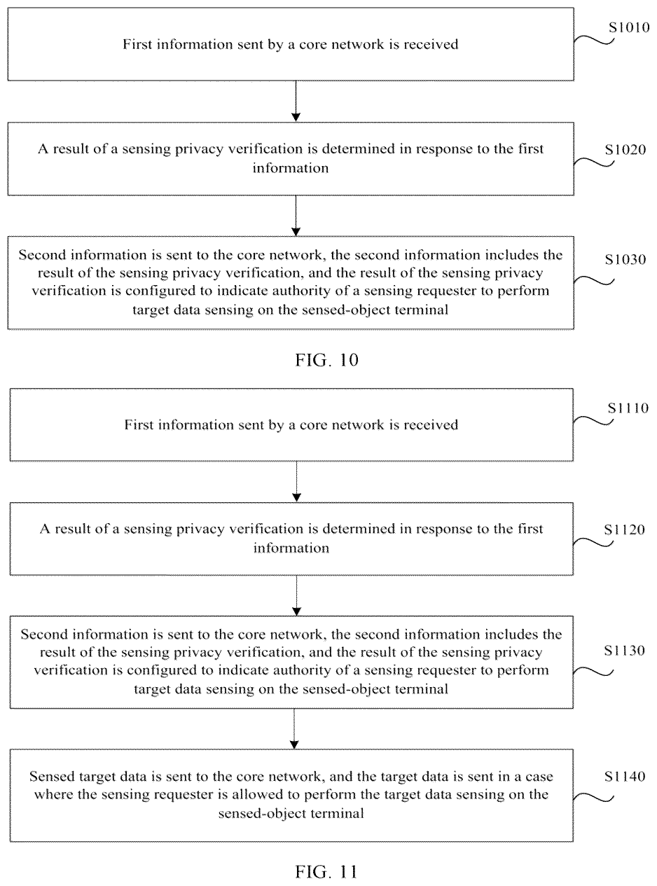

FIG. 10 shows a data sensing method according to one or more embodiments of the present disclosure, which can be applied to a sensed-object terminal in the above communication system. As shown in FIG. 10, the method can include following steps.

In step S1010, first information sent by a core network is received.

In step S1020, a result of a sensing privacy verification is determined in response to the first information.

In step S1030, second information is sent to the core network, the second information includes the result of the sensing privacy verification, and the result of the sensing privacy verification is configured to indicate authority of a sensing requester to perform target data sensing on the sensed-object terminal.

According to the above method provided by embodiments of the present disclosure, the sensed-object terminal can receive the first information sent by the core network, determine the result of the sensing privacy verification in response to the first information, and then send the second information to the core network. Due to the fact that the result of the sensing privacy verification is used to indicate the authority of the sensing requester to perform the target data sensing on the sensed-object terminal, the sensed-object terminal can verify the sensing authority of the sensing requester, and then decide whether to agree with the sensing requester to perform the target data sensing on it (the sensed-object terminal). By means of the authority verification process, the transmission process of the sensed data by the sensed-object terminal can be protected and the security of the sensed-object terminal can be improved.

FIG. 11 shows a data sensing method according to one or more embodiments of the present disclosure, which can be applied to the sensed-object terminal. As shown in FIG. 11, the method can include following steps.

In step S1110, first information sent by a core network is received.

In step S1120, a result of a sensing privacy verification is determined in response to the first information.

In step S1130, second information is sent to the core network, the second information includes the result of the sensing privacy verification, and the result of the sensing privacy verification is configured to indicate authority of a sensing requester to perform target data sensing on the sensed-object terminal.

In step S1140, sensed target data is sent to the core network, and the target data is sent in a case where the sensing requester is allowed to perform the target data sensing on the sensed-object terminal.

In embodiments of the present disclosure, if the result of the sensing privacy verification is that the sensing requester is allowed to perform the target data sensing on the sensed-object terminal, the sensed-object terminal can send the sensed target data to the core network, so that the core network can receive the sensed target data sent by the sensed-object terminal.

In some embodiments, the core network can send the sensed target data to the sensing requester after receiving the sensed target data from the sensed-object terminal.

According to the above method provided by embodiments of the present disclosure, the target data can be sent from the sensed-object terminal to the core network after the sensed-object terminal agrees with the sensing requester to perform the target data sensing on it, which can protect the transmission process of the sensed data by the sensed-object terminal and improve the security of the sensed-object terminal.

In some embodiments, the process of sending the sensed target data to the core network in step S1140 can be performed simultaneously with the process of sending the second information to the core network in step S1130, that is, the target data can be carried in the second information. That is, the sensed-object terminal can carry both the result of the sensing privacy verification and the target data in the second information, and send them together to the core network.

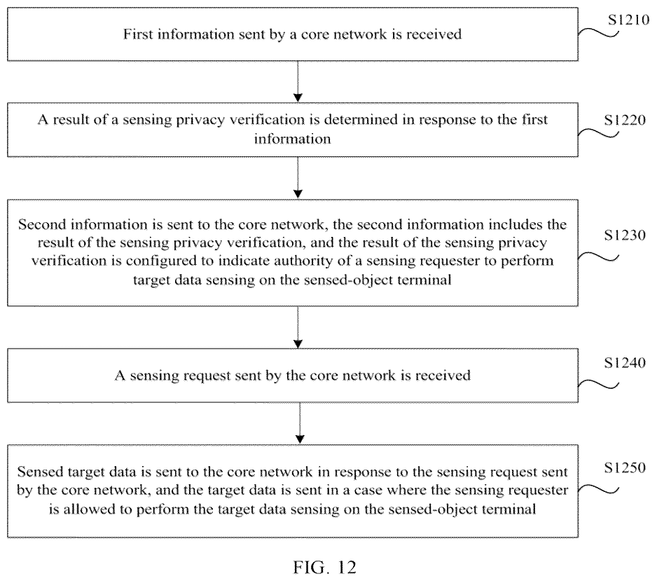

In some embodiments, the process of sending the second information to the core network in step S1130 and the process of sending the sensed target data to the core network in step S1140 can also be independently performed in sequence. In this case, in some embodiments, the sensed-object terminal can actively send the sensed target data to the core network. In some other embodiments, the core network can send the sensed-object terminal a message configured to request for the target data, so that the sensed-object terminal can send the sensed target data to the core network in response to the message configured to request for the target data after the message configured to request for the target data is received by the sensed-object terminal. Reference can be made to FIG. 12, a data sensing method according to one or more embodiments of the present disclosure is illustrated, which can be applied to the sensed-object terminal. As shown in FIG. 12, the method can include following steps.

In step S1210, first information sent by a core network is received.

In step S1220, a result of a sensing privacy verification is determined in response to the first information.

In step S1230, second information is sent to the core network, the second information includes the result of the sensing privacy verification, and the result of the sensing privacy verification is configured to indicate authority of a sensing requester to perform target data sensing on the sensed-object terminal.

In step S1240, a sensing request sent by the core network is received.

In step S1250, sensed target data is sent to the core network in response to the sensing request sent by the core network, and the target data is sent in a case where the sensing requester is allowed to perform the target data sensing on the sensed-object terminal.

In some embodiments, the sensing request sent by the core network can be generated by the core network itself. For example, the sensing request can be generated by the core network when the core network receives the second information and in a case where the second information indicates that the sensing requester is allowed to perform the target data sensing on the sensed-object terminal, or the sensing request can be a sensing request sent again by the sensing requester.

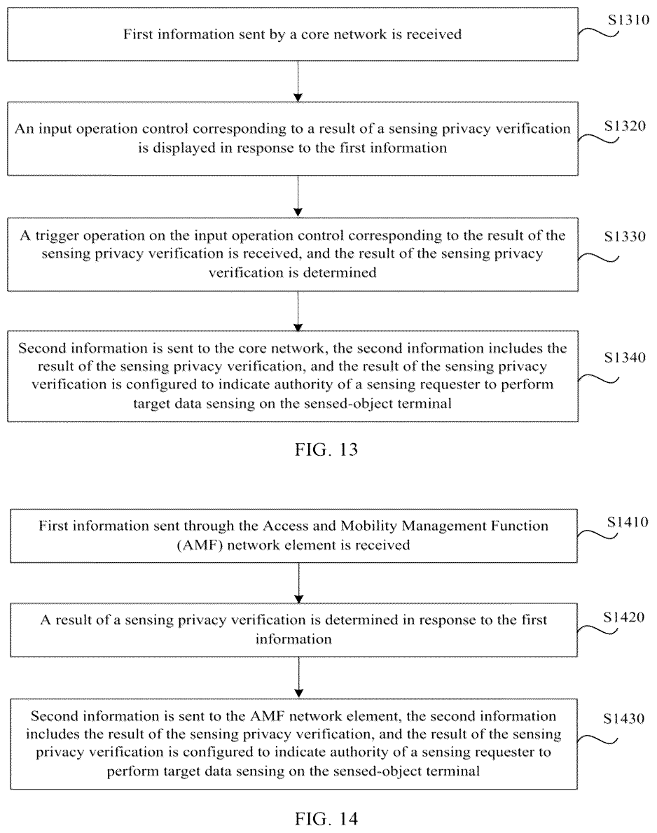

FIG. 13 shows a data sensing method according to one or more embodiments of the present disclosure, which can be applied to the sensed-object terminal. As shown in FIG. 13, the method can include following steps.

In step S1310, first information sent by a core network is received.

In step S1320, an input operation control corresponding to a result of a sensing privacy verification is displayed in response to the first information.

In step S1330, a trigger operation on the input operation control corresponding to the result of the sensing privacy verification is received, and the result of the sensing privacy verification is determined.

In step S1340, second information is sent to the core network, the second information includes the result of the sensing privacy verification, and the result of the sensing privacy verification is configured to indicate authority of a sensing requester to perform target data sensing on the sensed-object terminal.

In embodiments of the present disclosure, after receiving the first information, the sensed-object terminal can display an input operation control corresponding to the result of the sensing privacy verification to an operator, such as a user of the sensed-object terminal. Therefore, a trigger operation from the operator can be exerted on the input operation control according to situations, and the sensed-object terminal can thus determine the result of the sensing privacy verification based on the trigger operation from the operator.

In some embodiments, in order to facilitate the operator in understanding of the sense-requesting terminal, a first identifier can also be displayed in response to the first information.

In some embodiments, the input operation control includes at least one of the following: a selection control indicating that the sensing requester is allowed to perform the target data sensing on the sensed-object terminal, a selection control indicating that the sensing requester is not allowed to perform the target data sensing on the sensed-object terminal, an input control indicating the reason for not allowance of the sensing requester to perform the target data sensing on the sensed-object terminal, an input control indicating the identifier of the device that is allowed to perform the target data sensing on the sensed-object terminal, or an input control indicating the identifier of the device that is not allowed to perform the target data sensing on the sensed-object terminal.

According to the above method provided by embodiments of the present disclosure, the authority of the sensing requester to perform the target data sensing on the sensed-object terminal can be determined by the operator of the sensed-object terminal.

In some embodiments, after receiving the first information sent by the core network, the sensed-object terminal can also directly determine the result of the sensing privacy verification according to a preset policy, and thus send the second information to the core network.

FIG. 14 shows a data sensing method according to one or more embodiments of the present disclosure, which can be applied to the sensed-object terminal. The core network includes an Access and Mobility Management Function (AMF) network element. As shown in FIG. 14, the method can include following steps.

In step S1410, first information sent by the Access and Mobility Management Function (AMF) network element is received.

In some embodiments, the sensed-object terminal can receive a Non Access Stratum (NAS) notification message sent by the AMF network element, with the NAS notification message including the first information.

In step S1420, a result of a sensing privacy verification is determined in response to the first information.

In step S1430, second information is sent to the AMF network element, the second information includes the result of the sensing privacy verification, and the result of the sensing privacy verification is configured to indicate authority of a sensing requester to perform target data sensing on the sensed-object terminal.

In some embodiments, the sensed-object terminal can send a Non Access Stratum (NAS) notification response to the AMF network element, with the NAS notification response including the second information.

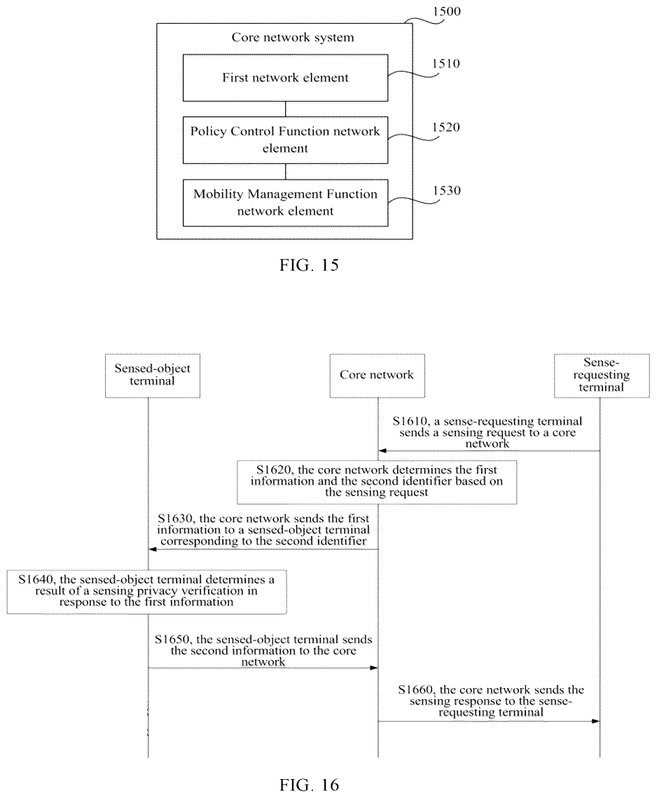

FIG. 15 shows a core network system 1500 according to one or more embodiments of the present disclosure. As shown in FIG. 15, the core network system 1500 includes a first network element 1510, a Policy Control Function (PCF) network element 1520, and an Access and Mobility Management Function (AMF) network element 1530.

The first network element 1510 is configured to determine the second identifier of the sensed-object terminal and the first information, and send the first information and the second identifier to the PCF network element.

The PCF network element 1520 is configured to send the first information and the second identifier to the AMF network element.

The AMF network element 1530 is configured to send the first information to the terminal corresponding to the second identifier, and receive the second information sent by the sensed-object terminal. The second information includes the result of the sensing privacy verification, and the result of the sensing privacy verification is configured to indicate authority of a sensing requester to perform target data sensing on the sensed-object terminal.

In some embodiments, the AMF network element 1530 is further configured to send the second information to the PCF network element.

The PCF network element is further configured to send the second information to the first network element.

In some embodiments, the sensing requester is the sense-requesting terminal connected to the core network system 1500, and the first network element 1510 is further configured to send a sensing response to the sense-requesting terminal. The sensing response includes at least one of the sensed target data, the information indicating that the sense-requesting terminal is not allowed to perform the target data sensing on the sensed-object terminal, and the information indicating the reason for not allowance of the sense-requesting terminal to perform the target data sensing on the sensed-object terminal. The target data is sent in the case where the sensing requester is allowed to perform the target data sensing on the sensed-object terminal.

In addition, according to embodiments of the present disclosure, a core network network element is also provided. The core network network element can be the first network element in FIG. 15. The core network network element is connected to the PCF network element in the core network. The core network network element is configured to determine the first information and the second identifier, and send the first information to the sensed-object terminal corresponding to the second identifier through the PCF network element. The first information is configured for the sensed-object terminal to determine the result of the sensing privacy verification.

In some embodiments, the process of the core network network element sending the first information to the sensed-object terminal corresponding to the second identifier through the PCF network element can refer to the relevant descriptions in the embodiments described in the above. In some embodiments, the first information and the second identifier can be sent to the PCF network element first, and can be sent to the AMF network element through the PCF network element then. Next, the first information is sent to the terminal corresponding to the second identifier through the AMF network element.

In addition, in some embodiments, the core network network element can also receive the second information and the sensing response from the sensed-object terminal. In some embodiments, the detailed descriptions of the core network network element receiving the second information and the sensing response from the sensed-object terminal can refer to the embodiments described in the above, which will not be repeated here.

FIG. 16 shows a data sensing method according to one or more embodiments of the present disclosure. As shown in FIG. 16, the data sensing method can include following steps.

In step S1610, a sense-requesting terminal sends a sensing request to a core network.

In some embodiments, the sensing request includes a first identifier of the sense-requesting terminal, a second identifier of a sensed-object terminal, and information indicating a type of target data to be sensed.

In step S1620, the core network determines the first information and the second identifier based on the sensing request.

In some embodiments, the first information includes the first identifier, the information indicating the type of the target data to be sensed, and sensing privacy verification indication information.

In step S1630, the core network sends the first information to a sensed-object terminal corresponding to the second identifier.

In step S1640, the sensed-object terminal determines a result of a sensing privacy verification in response to the first information.

In step S1650, the sensed-object terminal sends the second information to the core network.

In some embodiments, the second information includes the result of the sensing privacy verification, which is configured to indicate authority of a sensing requester to perform target data sensing on the sensed-object terminal.

In step S1660, the core network sends the sensing response to the sense-requesting terminal.

In some embodiments, the sensing response is the sensed target data, which is sent in a case where the sensing requester is allowed to perform the target data sensing on the sensed-object terminal.

In some embodiments, the sensing response is information indicating that the sense-requesting terminal is not allowed to perform the target data sensing on the sensed-object terminal.

In some embodiments, the sensing response is information indicating that the sense-requesting terminal is not allowed to perform the target data sensing on the sensed-object terminal, as well as information indicating a reason for not allowance of the sense-requesting terminal to perform the target data sensing on the sensed-object terminal.

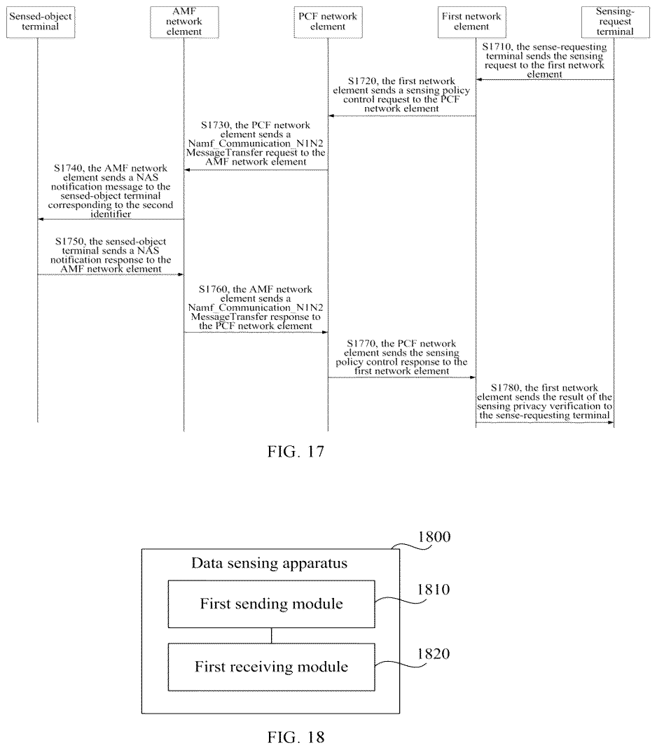

FIG. 17 shows a data sensing method according to one or more embodiments of the present disclosure. As shown in FIG. 17, the data sensing method can include following steps.

In step S1710, the sense-requesting terminal sends a sensing request to a first network element.

In some embodiments, the sensing request includes a first identifier of the sense-requesting terminal, a second identifier of a sensed-object terminal, and information indicating a type of target data to be sensed.

In step S1720, the first network element sends a sensing policy control request to the PCF network element.

In some embodiments, the sensing policy control request includes the first identifier, the second identifier, the information indicating the type of the target data to be sensed, and sensing privacy verification indication information.

In step S1730, the PCF network element sends a Namf Communication_N1N2MessageTransfer request to the AMF network element.

In some embodiments, the Namf_Communication_N1N2MessageTransfer request includes the second identifier and an N1 message, and the N1 message includes the first identifier, the information indicating the type of the target data to be sensed, and the sensing privacy verification indication information.

In step S1740, the AMF network element sends a NAS notification message to the sensed-object terminal corresponding to the second identifier.

In some embodiments, the NAS notification message includes the N1 message.

In step S1750, the sensed-object terminal sends a NAS notification response to the AMF network element.

In some embodiments, the NAS notification response includes the result of the sensing privacy verification.

In step S1760, the AMF network element sends a Namf_Communication_N1N2MessageTransfer response to the PCF network element.

In some embodiments, the Namf_Communication_N1N2MessageTransfer response includes the result of the sensing privacy verification.

In step S1770, the PCF network element sends a sensing policy control response to the first network element.

In some embodiments, the sensing policy control response includes the result of the sensing privacy verification.

In step S1780, the first network element sends the result of the sensing privacy verification to the sense-requesting terminal.

FIG. 18 is a block diagram of a data sensing apparatus 1800 according to one or more embodiments of the present disclosure, which can be applied to the core network. As shown in FIG. 18, the apparatus 1800 can include a first sending module 1810 and a first receiving module 1820.

The first sending module 1810 is configured to send first information to a sensed-object terminal. The first information is configured for the sensed-object terminal to determine a result of a sensing privacy verification.

The first receiving module 1820 is configured to receive second information sent by the sensed-object terminal. The second information includes the result of the sensing privacy verification, and the result of the sensing privacy verification is configured to indicate authority of a sensing requester to perform target data sensing on the sensed-object terminal.

In some embodiments, the apparatus 1800 further includes a second receiving module.

The second receiving module is configured to receive sensed target data sent by the sensed-object terminal. The target data is sent in a case where the sensing requester is allowed to perform the target data sensing on the sensed-object terminal.

In some embodiments, the sensing requester is a sense-requesting terminal connected to the core network, and the first sending module 1810 includes a receiving submodule and a first sending submodule.

The receiving submodule is configured to receive a sensing request sent by the sense-requesting terminal.

The first sending submodule is configured to send the first information to the sensed-object terminal in response to the sensing request.

In some embodiments, the sensing request includes a first identifier of the sense-requesting terminal, a second identifier of the sensed-object terminal, and information indicating a type of target data to be sensed, and the first sending submodule is further configured to generate sensing privacy verification indication information in response to the sensing request, and send the first identifier, the information indicating the type of the target data to be sensed, and the sensing privacy verification indication information, as the first information, to a terminal corresponding to the second identifier.

In some embodiments, the apparatus 1800 further includes a second sending module.

The second sending module is configured to send a sensing response to the sense-requesting terminal. The sensing response includes at least one of the following: sensed target data, information indicating that the sense-requesting terminal is not allowed to perform the target data sensing on the sensed-object terminal, or information indicating a reason for not allowance of the sense-requesting terminal to perform the target data sensing on the sensed-object terminal. The target data is sent in a case where the sensing requester is allowed to perform the target data sensing on the sensed-object terminal.

In some embodiments, the core network includes a first network element, a Policy Control Function (PCF) network element, and an Access and Mobility Management Function (AMF) network element, and the first sending module 1810 includes a determination submodule, a second sending submodule, a third sending submodule, and a fourth sending submodule.

The determination submodule is configured to determine, through the first network element, the first information and a second identifier of the sensed-object terminal.

The second sending submodule is configured to send, through the first network element, the first information and the second identifier to the PCF network element.

The third sending submodule is configured to send, through the PCF network element, the first information and the second identifier to the AMF network element.

The fourth sending submodule is configured to send, through the AMF network element, the first information to a terminal corresponding to the second identifier.

In some embodiments, the second sending submodule is further configured to send, through the first network element, a first request to the PCF network element. The first request includes the first information and the second identifier.

In some embodiments, the third sending submodule is further configured to send, through the PCF network element, a Namf_Communication_N1N2MessageTransfer request to the AMF network element. The Namf Communication_N1N2MessageTransfer request includes the second identifier and an N1 message, with the N1 message including the first information.

In some embodiments, the fourth sending submodule is further configured to send, through the AMF network element, a NAS notification message to the terminal corresponding to the second identifier. The NAS notification message includes the first information.

In some embodiments, the information configured to indicate the authority of the sensing requester to perform the target data sensing on the sensed-object terminal includes at least one of the following: information indicating that the sensing requester is allowed to perform the target data sensing on the sensed-object terminal, information indicating that the sensing requester is not allowed to perform the target data sensing on the sensed-object terminal, information indicating a reason for not allowance of the sensing requester to perform the target data sensing on the sensed-object terminal, an identifier of a device that is allowed to perform the target data sensing on the sensed-object terminal, or an identifier of a device that is not allowed to perform the target data sensing on the sensed-object terminal.

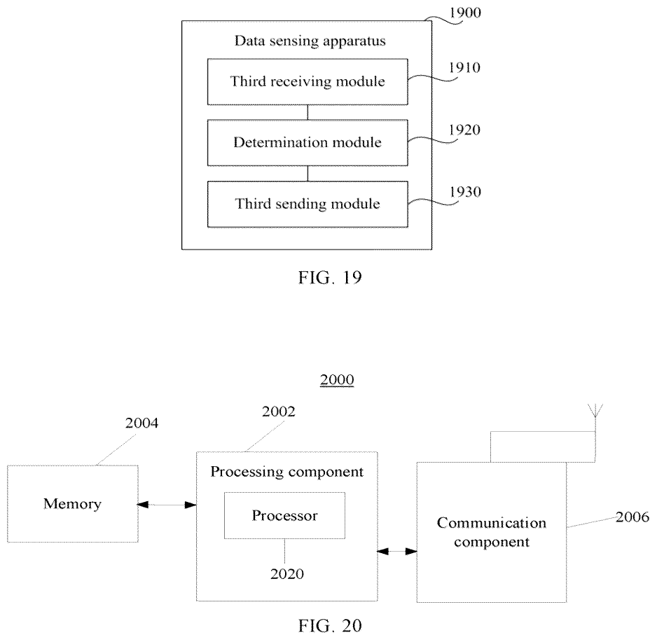

FIG. 19 is a block diagram of a data sensing apparatus 1900 according to one or more embodiments of the present disclosure, which can be applied to the sensed-object terminal. As shown in FIG. 19, the apparatus 1900 can include a third receiving module 1910, a determination module 1920, and a third sending module 1930.

The third receiving module 1910 is configured to receive first information sent by a core network.

The determination module 1920 is configured to determine a result of a sensing privacy verification in response to the first information.

The third sending module 1930 is configured to send second information to the core network. The second information includes the result of the sensing privacy verification, and the result of the sensing privacy verification is configured to indicate authority of a sensing requester to perform target data sensing on the sensed-object terminal.

In some embodiments, the apparatus 1900 further includes a fourth sending module.

The fourth sending module is configured to send sensed target data to the core network. The target data is sent in a case where the sensing requester is allowed to perform the target data sensing on the sensed-object terminal.

In some embodiments, the fourth sending module is further configured to receive a sensing request sent by the core network, and send the sensed target data to the core network in response to the sensing request.

In some embodiments, the determination module 1920 is further configured to display an input operation control corresponding to the result of the sensing privacy verification in response to the first information, receive a trigger operation on the input operation control corresponding to the result of the sensing privacy verification, and determine the result of the sensing privacy verification.

In some embodiments, the input operation control includes at least one of: a selection control indicating that the sensing requester is allowed to perform the target data sensing on the sensed-object terminal, a selection control indicating that the sensing requester is not allowed to perform the target data sensing on the sensed-object terminal, an input control indicating a reason for not allowance of the sensing requester to perform the target data sensing on the sensed-object terminal, an input control indicating an identifier of a device that is allowed to perform the target data sensing on the sensed-object terminal, or an input control indicating an identifier of a device that is not allowed to perform the target data sensing on the sensed-object terminal.

In some embodiments, the core network includes an Access and Mobility Management Function (AMF) network element, and the third receiving module 1910 is further configured to receive the first information sent by the AMF network element.

In some embodiments, the core network includes the AMF network element, and the third sending module 1930 is further configured to send the second information to the AMF network element.

Regarding the apparatus in the above embodiments, the specific ways in which each module performs operations have been described in detail in the relevant method embodiments, and will not be repeated here.

FIG. 20 is a block diagram of a data sensing device according to one or more embodiments of the present disclosure. The data sensing device 2000 can be the core network in the communication system shown in FIG. 1. As shown in FIG. 20, the device 2000 can include one or more of the following components: a processing component 2002, a memory 2004, and a communication component 2006.

The processing component 2002 can be used to control the overall operation of the device 2000, such as operations associated with display, data communication, camera operations, and recording operations. The processing component 2002 can include one or more processors 2020 to execute instructions to complete all or part of the steps of the data sensing method described in the above. In addition, the processing component 2002 can include one or more modules to facilitate interactions between the processing component 2002 and other components. For example, the processing component 2002 can include a multimedia module to facilitate the interaction between the multimedia component and the processing component 2002.

The memory 2004 is configured to store various types of data to support operations of the device 2000. Examples of such data include instructions, contact data, phone book data, messages, pictures, videos, and the like for any application or method operating on device 2000. The memory 2004 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The communication component 2006 is configured to facilitate wired or wireless communication between the device 2000 and other devices. The device 2000 can access wireless networks based on communication standards, such as WiFi, 2G, 3G, 4G, 5G, 6G, NB-IOT, eMTC, or their combinations. In some embodiments, the communication component 2006 receives a broadcast signal or broadcast related information from an external broadcast management system via a broadcast channel. In some embodiments, the communication component 2006 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

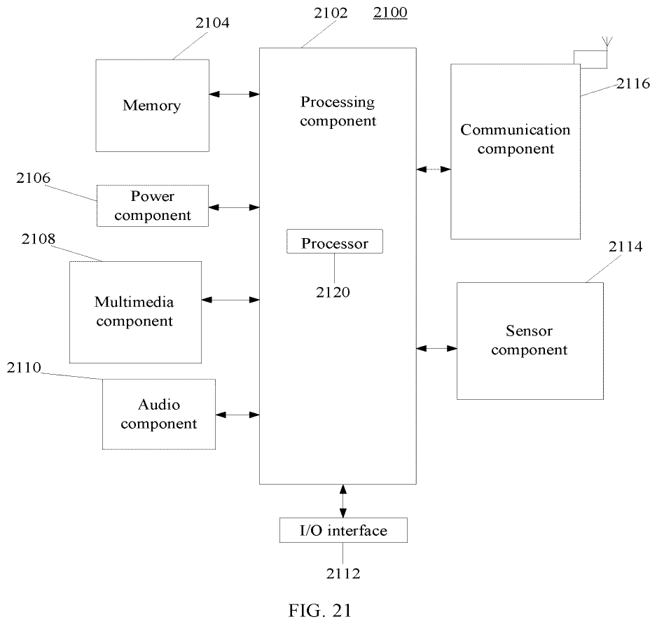

FIG. 21 is a block diagram of a data sensing device according to one or more embodiments of the present disclosure. For example, the data sensing device 2100 can be the sensed-object terminal in the communication system shown in FIG. 1, which can be, for example, a mobile phone, a camera, a laptop, a tablet computer, or a smart wearable device.

As shown in FIG. 21, the data sensing device 2100 can include one or more of the following components: a processing component 2102, a memory 2104, a power component 2106, a multimedia component 2108, an audio component 2110, an input/output interface 2112, a sensor component 2114, and a communication component 2116.

The processing component 2102 typically controls the overall operation of the data sensing device 2100, such as operations associated with display, telephone call, data communication, camera operation, and recording operations. The processing component 2102 can include one or more processors 2120 to execute instructions to complete all or part of the above information reporting methods performed by the user-side device. In addition, the processing component 2102 can include one or more modules to facilitate interactions between the processing component 2102 and other components. For example, the processing component 2102 can include a multimedia module to facilitate the interaction between the multimedia component 2108 and the processing component 2102.

The memory 2104 is configured to store various types of data to support operations on the data sensing device 2100. Examples of such data include instructions, contact data, phone book data, messages, pictures, videos, and the like for any application or method operating on the data sensing device 2100. The memory 2104 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 2106 provides power for various components of the data sensing device 2100. The power component 2106 can include a power management system, one or more power supplies, and other components associated with generating, managing, and distributing power for the data sensing device 2100.

The multimedia component 2108 includes a display screen providing an output interface between the data sensing device 2100 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 2108 includes a front camera and/or a rear camera. When the data sensing device 2100 is in operation mode, such as shooting mode or video mode, the front camera and/or rear camera can receive external multimedia data. Each front camera and rear camera can be a fixed optical lens system or have focal length and optical zoom capability.

The audio component 2110 is configured to output and/or input audio signals. For example, the audio component 2110 includes a microphone (MIC), which is configured to receive an external audio signal when the data sensing device 2100 is in an operation mode, such as a calling mode, a recording mode, and a voice recognition mode. The received audio signal may be further stored in memory 2104 or transmitted via communication component 2116. In some embodiments, the audio component 2110 also includes a speaker for outputting audio signals.

The I/O interface 2112 provides an interface between the processing component 2102 and peripheral interface modules, which can be a keyboard, a click wheel, a button, etc. These buttons may include, but are not limited to, the Home button, Volume button, Start button, and Lock button.

The sensor component 2114 includes one or more sensors for providing various aspects of condition evaluation for the data sensing device 2100. For example, the sensor component 2114 can detect an open/closed state of the data sensing device 2100, relative positioning of the components. The component is, for example, a display and a keypad of the data sensing device 2100. The sensor component 2114 can also detect changes in the position of the data sensing device 2100 or one component of the data sensing device 2100, presence or absence of the user's contact with the data sensing device 2100, orientation or acceleration/deceleration of the data sensing device 2100 and temperature change of the data sensing device 2100. The sensor component 2114 may include a proximity sensor configured to detect the presence of nearby objects without any physical contact. The sensor component 2114 may also include a light sensor, such as a CMOS or CCD image sensor, for use in imaging applications. In some embodiments, the sensor component 2114 may also include an acceleration sensor, a gyroscope sensor, a magnetic sensor, a pressure sensor, or a temperature sensor.

The communication component 2116 is configured to facilitate wired or wireless communication between the data sensing device 2100 and other devices. The data sensing device 2100 can access wireless networks based on communication standards, such as WiFi, 2G or 3G, or a combination thereof. In some embodiments, the communication component 2116 receives a broadcast signal or broadcast related information from an external broadcast management system via a broadcast channel. In some embodiments, the communication component 2116 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the device 2000 or the data sensing device 2100 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing the above data sensing methods.

The above-mentioned device 2000 or device 2100 can be an independent electronic device or a part of an independent electronic device. For example, in some embodiments, the electronic device can be an integrated circuit (IC) or a chip, where the integrated circuit can be one IC or a collection of multiple ICs. The chip can include but is not limited to the following types: GPU (Graphics Processing Unit), CPU (Central Processing Unit), FPGA (Field Programmable Gate Array), DSP (Digital Signal Processor), ASIC (Application Specific Integrated Circuit), SOC (System on Chip, SoC, System on Chip or system-level chip), etc. The above integrated circuits or chips can be used to execute executable instructions (or codes) to implement the above data sensing methods. The executable instructions can be stored in the integrated circuit or in the chip, or obtained from other devices or equipment, such as processors, memories, and interfaces for communication with other devices included in the integrated circuit or the chip. The executable instructions can be stored in the processor, and when the executable instructions are executed by the processor, the above data sensing methods are implemented. Alternatively, the integrated circuit or the chip can receive executable instructions through the interface and transmit them to the processor for execution, in order to implement the aforementioned data sensing methods.

In some embodiments, the present disclosure also provides a computer-readable storage medium storing computer program instructions. When the computer program instructions are executed by a processor, the steps of the data sensing methods provided in the present disclosure are executed. For example, the computer-readable storage medium can be a non-transitory computer-readable storage medium containing instructions, such as the above-mentioned memory 2004 or 2104 containing instructions, which can be executed by the processor 2020 of the device 2000 or the processor 2120 of the device 2100 to complete the above data sensing methods. For example, the non-transitory computer-readable storage medium can be ROM, random access memory (RAM), CD-ROM, magnetic tape, floppy disk, and optical data storage devices.

In some embodiments, there is also provided a computer program product including a computer program executable by a programmable device, the computer program having code portions for executing the data sensing methods described above when executed by the programmable device.

After considering the specification and practicing the embodiments disclosed herein, those skilled in the art will easily come up with other embodiments of the present disclosure. The present disclosure is intended to cover any variations, uses, or adaptive changes of the present disclosure that follow the general principles of the present disclosure and include common knowledge or customary technical means in the art that are not disclosed herein. The specification and embodiments are considered as exemplary only, and the true scope and spirit of the present disclosure are indicated by the appended claims.

It should be understood that the present disclosure is not limited to the precise structure described above and shown in the drawings, and various modifications and changes can be made without departing from the scope thereof. The scope of the present disclosure is limited only by the appended claims.

What is claimed is:

1. A data sensing method, performed by a core network, the method comprising:
sending first information to a sensed-object terminal, wherein the first information is configured for the sensed-object terminal to determine a result of a sensing privacy verification; and
receiving second information sent by the sensed-object terminal, wherein the second information comprises the result of the sensing privacy verification, and the result of the sensing privacy verification is configured to indicate authority of a sensing requester to perform target data sensing on the sensed-object terminal.

2. The method according to claim 1, further comprising:
receiving sensed target data sent by the sensed-object terminal, wherein the target data is sent in a case where the sensing requester is allowed to perform the target data sensing on the sensed-object terminal.

3. The method according to claim 1, wherein the sensing requester is a sense-requesting terminal connected to the core network, and sending the first information to the sensed-object terminal comprises:
receiving a sensing request sent by the sense-requesting terminal; and
sending the first information to the sensed-object terminal in response to the sensing request.

4. The method according to claim 3, wherein the sensing request comprises a first identifier of the sense-requesting terminal, a second identifier of the sensed-object terminal, and information indicating a type of target data to be sensed, and sending the first information to the sensed-object terminal in response to the sensing request comprises:
generating sensing privacy verification indication information in response to the sensing request; and
sending the first identifier, the information indicating the type of the target data to be sensed, and the sensing privacy verification indication information, as the first information, to a terminal corresponding to the second identifier.

5. The method according to claim 3, further comprising:
sending a sensing response to the sense-requesting terminal, wherein the sensing response comprises at least one of sensed target data, information indicating that the sense-requesting terminal is not allowed to perform the target data sensing on the sensed-object terminal, or information indicating a reason for not allowance of the sense-requesting terminal to perform the target data sensing on the sensed-object terminal, wherein the target data is sent in a case where the sensing requester is allowed to perform the target data sensing on the sensed-object terminal.

6. The method according to claim 1, wherein the core network comprises a first network element, a Policy Control Function (PCF) network element, and an Access and Mobility Management Function (AMF) network element, and sending the first information to the sensed-object terminal comprises:
determining, through the first network element, the first information and a second identifier of the sensed-object terminal;
sending, through the first network element, the first information and the second identifier to the PCF network element;
sending, through the PCF network element, the first information and the second identifier to the AMF network element; and
sending, through the AMF network element, the first information to a terminal corresponding to the second identifier.

7. The method according to claim 6, wherein sending, through the first network element, the first information and the second identifier to the PCF network element comprises:
sending, through the first network element, a first request to the PCF network element, wherein the first request comprises the first information and the second identifier.

8. The method according to claim 6, wherein sending, through the PCF network element, the first information and the second identifier to the AMF network element comprises:
sending, through the PCF network element, a second request to the AMF network element, wherein the second request comprises the second identifier and the first information.

9. The method according to claim 6, wherein sending, through the AMF network element, the first information to the terminal corresponding to the second identifier comprises:
sending, through the AMF network element, a notification message to the terminal corresponding to the second identifier, wherein the notification message comprises the first information.

10. The method according to any of claims 1 to 9, wherein information configured to indicate the authority of the sensing requester to perform the target data sensing on the sensed-object terminal comprises at least one of: information indicating that the sensing requester is allowed to perform the target data sensing on the sensed-object terminal, information indicating that the sensing requester is not allowed to perform the target data sensing on the sensed-object terminal, information indicating a reason for not allowance of the sensing requester to perform the target data sensing on the sensed-object terminal, an identifier of a device that is allowed to perform the target data sensing on the sensed-object terminal, or an identifier of a device that is not allowed to perform the target data sensing on the sensed-object terminal.

11. A data sensing method, performed by a sensed-object terminal, the method comprising:
receiving first information sent by a core network;
determining a result of a sensing privacy verification in response to the first information; and
sending second information to the core network, wherein the second information comprises the result of the sensing privacy verification, and the result of the sensing privacy verification is configured to indicate authority of a sensing requester to perform target data sensing on the sensed-object terminal.

12. The method according to claim 11, further comprising:
sending sensed target data to the core network, wherein the target data is sent in a case where the sensing requester is allowed to perform the target data sensing on the sensed-object terminal.

13. The method according to claim 12, wherein sending the sensed target data to the core network comprises:
receiving a sensing request sent by the core network; and
sending the sensed target data to the core network in response to the sensing request.

14. The method according to claim 11, wherein determining the result of the sensing privacy verification in response to the first information comprises:
displaying an input operation control corresponding to the result of the sensing privacy verification in response to the first information;
receiving a trigger operation on the input operation control corresponding to the result of the sensing privacy verification; and
determining the result of the sensing privacy verification.

15. The method according to claim 14, wherein the input operation control comprises at least one of: a selection control indicating that the sensing requester is allowed to perform the target data sensing on the sensed-object terminal, a selection control indicating that the sensing requester is not allowed to perform the target data sensing on the sensed-object terminal, an input control indicating a reason for not allowance of the sensing requester to perform the target data sensing on the sensed-object terminal, an input control indicating an identifier of a device that is allowed to perform the target data sensing on the sensed-object terminal, or an input control indicating an identifier of a device that is not allowed to perform the target data sensing on the sensed-object terminal.

16. The method according to claim 11, wherein the core network comprises an Access and Mobility Management Function (AMF) network element, and receiving the first information sent by the core network comprises:
receiving the first information sent by the AMF network element.

17. The method according to claim 11, wherein the core network comprises an AMF network element, and sending the second information to the core network comprises:
sending the second information to the AMF network element.

18. A core network system, comprising a first network element, a Policy Control Function (PCF) network element, and an Access and Mobility Management Function (AMF) network element, wherein
the first network element is configured to determine first information and a second identifier of a sensed-object terminal, and send the first information and the second identifier to the PCF network element;
the PCF network element is configured to send the first information and the second identifier to the AMF network element; and
the AMF network element is configured to send the first information to a terminal corresponding to the second identifier, and receive second information sent by the sensed-object terminal, wherein the second information comprises a result of a sensing privacy verification, and the result of the sensing privacy verification is configured to indicate authority of a sensing requester to perform target data sensing on the sensed-object terminal.

19. The system according to claim 18, wherein
the AMF network element is further configured to send the second information to the PCF network element; and
the PCF network element is further configured to send the second information to the first network element.

20. The system according to claim 19, wherein the sensing requester is a sense-requesting terminal connected to the core network system, and the first network element is further configured to send a sensing response to the sense-requesting terminal, wherein the sensing response comprises at least one of sensed target data, information indicating that the sense-requesting terminal is not allowed to perform the target data sensing on the sensed-object terminal, or information indicating a reason for not allowance of the sense-requesting terminal to perform the target data sensing on the sensed-object terminal, and wherein the target data is sent in a case where the sensing requester is allowed to perform the target data sensing on the sensed-object terminal.

21. The system according to claim 18, wherein the sensing requester is a sense-requesting terminal connected to the core network system, and the first network element is configured to receive a sensing request sent by the sense-requesting terminal connected to the core network system, and determine the first information and the second identifier of the sensed-object terminal based on the sensing request.

22. The system according to any of claims 18 to 21, wherein information configured to indicate the authority of the sensing requester to perform the target data sensing on the sensed-object terminal comprises at least one of: information indicating that the sensing requester is allowed to perform the target data sensing on the sensed-object terminal, information indicating that the sensing requester is not allowed to perform the target data sensing on the sensed-object terminal, information indicating a reason for not allowance of the sensing requester to perform the target data sensing on the sensed-object terminal, an identifier of a device that is allowed to perform the target data sensing on the sensed-object terminal, or an identifier of a device that is not allowed to perform the target data sensing on the sensed-object terminal.

23. A core network network element, wherein the core network network element is connected to a Policy Control Function (PCF) network element in the core network, and the core network network element is configured to determine first information and a second identifier, and send the first information to a sensed-object terminal corresponding to the second identifier through the PCF network element, and wherein the first information is configured for the sensed-object terminal to determine a result of a sensing privacy verification.

24. A data sensing device, comprising:
a processor; and
a memory for storing instructions executable by the processor;
wherein the processor is configured to execute steps of the method described in any of claims 1 to 10, or the processor is configured to execute steps of the method described in any of claims 11 to 17.

25. A chip comprising a processor and an interface, wherein the processor is configured to read instructions to execute steps of the method described in any of claims 1 to 10, or the processor is configured to read instructions to execute steps of the method described in any of claims 11 to 17.
